(19) United States
(12) Patent Application Publication
(10) Pub. No.: US 2025/0167625 A1
(43) Pub. Date: May 22, 2025

(54) CONNECTION ARRANGEMENT AS A CONTACT BRIDGE BETWEEN AN ELECTRIC MOTOR AND A POWER ELECTRONICS SYSTEM

(71) Applicant: AUDI AG, Ingolstadt (DE)

(72) Inventors: Max POSSEN, Coburg (DE); Josef RUSCH, Großmehring (DE)

(21) Appl. No.: 18/955,465

(22) Filed: Nov. 21, 2024

(30) Foreign Application Priority Data
Nov. 22, 2023 (DE) 102023132589.2

(51) Int. Cl. H02K 5/22; B60R 16/03

(52) U.S. Cl. CPC H02K 5/225; B60R 16/03

(57) ABSTRACT

A connection arrangement for electrically connecting a power electronics system to a stator and an externally excited rotor of an electric motor is disclosed and may comprise a first connection region, a second connection region, at least two stator lines, at least two rotor lines, first connection contacts in the first connection regions, and second connection contacts in the second connection region. The first connection region may be configured to electrically couple to a power electronics system and may be rigidly configured. The second connection region may be configured to electrically couple to a stator and an externally excited rotor of the electric motor. The at least two stator lines and the at least two rotor lines may extend between the first connection region and the second connection region. Furthermore, an electric motor arrangement and a vehicle are disclosed.

### BACKGROUND

### Technical Field

The disclosure relates to a connection arrangement configured to electrically couple a power electronics system, an externally excited rotor, and a stator of an electric motor. The disclosure further relates to an electric motor arrangement and a vehicle.

### Description of the Related Art

Electric motors in the form of externally excited synchronous machines (ESM) are normally used to drive electric vehicles electrically. These electric motors must be controlled by pulse inverters (PI) in accordance with a control command or driver request. Controlling the electric motor in this way therefore requires two electrical lines to connect the rotor and, in the case of three-phase electric motors, three electrical lines to connect the stator.

In order to comply with the circulating currents in the stator and the limit values for the required electromagnetic compatibility, a ferrite core is also provided, which encloses the three electrical lines for connecting the stator to the pulse inverter.

These electrical lines and the ferrite core are usually designed as separate components.

In externally excited synchronous machines, the rotor winding must be supplied with electricity from the PI with 2 phases (+ and −). This connection (contacting) is carried out with a separate connection between the PI and the slip ring module (contacting the rotor).

The three components contact bridge, ferrite core and contact rotor current in ESM are individual components that must be installed individually.

DE102018103788A1 discloses a stator which can electrically contact several stator windings simultaneously via connecting pieces.

U.S. Patent Application Publication No. 2022/0077734 A1 describes a motor in which the electrical connection is made via a plug connector. U.S. Patent Application Publication No. 2004/0155540 A1 also describes an electric motor that can be electrically connected via a plug connector.

### BRIEF SUMMARY

The present disclosure includes a connection arrangement for an electric motor, by way of which the assembly can be simplified.

The connection arrangement according to the present disclosure is configured to form an electrically conductive connection between an electric motor and a power electronics system for controlling the electric motor. In addition to an electrical connection, a mechanical coupling may also be established between the power electronics system and the electric motor. The connection arrangement may be configured as a contact bridge between the electric motor and the power electronics system.

The connection arrangement may have a first connection region and a second connection region. The first connection region may be configured to electrically couple to a power electronics system. The second connection region may be configured to electrically couple or connect to an electric motor, in particular a stator and an externally excited rotor of the electric motor.

The connection arrangement may have at least two stator lines and at least two rotor lines. The stator lines and the rotor lines may run between the first connection region and the second connection region and have first connection contacts in the first connection region and second connection contacts in the second connection region. The first connection region may be configured to be rigid and is connected to the second connection region. In some embodiments, the first and second connection regions may form a rigid unit.

According to a further aspect of the present disclosure, an electric motor arrangement is provided. The electric motor arrangement may have at least one electric motor and at least one power electronics system. Furthermore, at least one connection arrangement according to the present disclosure may be provided. The power electronics system may be connected to the first connection region of the connection arrangement. The electric motor may be electrically connected to the second connection region. As a result, the connection arrangement may form an electrical and mechanical bridge between the electric motor and the power electronics system.

The power electronics system may be configured in the form of an inverter, in particular in the form of a pulse inverter. The electric motor may, for example, be an externally excited synchronous machine in which the rotor and the stator are supplied separately with electrical energy.

According to one aspect of the present disclosure, a vehicle may be provided which has at least one electric motor arrangement according to the present disclosure. The electric motor may be configured as a drive motor. A traction battery may be provided to supply the electric motor with electrical energy. A power electronics system may act as a control of the electric motor, for example to clock the stator of the electric motor at a predetermined frequency.

By forming the connection arrangement, the stator lines, rotor lines and the ferrite core, which are normally designed as individual components, may be combined into one component. Such a configuration may enable a reduction in the installation space required for the implementation of the HV (high-voltage) connections between the power electronics system and the stator windings. Furthermore, the logistics and assembly effort for the connection arrangement may be reduced.

In some embodiments, the first connection region may have an orientation rotated by 90° relative to the second connection region. As a result, the assembly direction for electrically contacting the connection contacts may also be rotated by 90° in order to simplify the connection of the connection arrangement to the power electronics system and the electric motor.

According to some embodiments, the first connection contacts may be electrically contacted along a height direction and the second connection may be electrically contacted along a length direction. Such a configuration may enable the connection contacts of the second connection region to be fastened laterally and the connection contacts of the first connection region to be fastened from above. The power electronics system may thus be placed on the connection arrangement, for example in the form of a module. The connection arrangement may extend laterally on the electric motor and be electrically coupled to the electric motor.

The height direction may, for example, be a height direction of a vehicle in which the connection arrangement may be used. The length direction may correspond to a direction of travel of the vehicle or be configured at least parallel to the direction of travel.

According to some embodiments, the connection arrangement may have at least one ferrite core. Such a configuration may enable a ferrite core to be integrated into the connection arrangement in order to achieve measures with regard to electromagnetic compatibility. The ferrite core may include one or multiple parts.

According to some embodiments, the ferrite core may be configured in a ring shape, with at least the stator lines being guided through the ferrite core. Such a configuration may enable the electromagnetic interference caused by the high-frequency energy transfer via the stator windings to be optimally dampened.

According to some embodiments, the first connection contacts and/or the second connection contacts may be configured in the form of cable end sections, contact plates, screw connections, and/or plug connections. Such a configuration may enable flexible electrical contacting of the connection contacts in the region of the electric motor and the power electronics system.

According to some embodiments, the connection arrangement may have a housing which is configured to accommodate and fasten stator lines, rotor lines, and/or the ferrite core. The housing may be configured to be hollow at least in sections in order to accommodate the stator lines, rotor lines, and/or the ferrite core. In an alternative or additional configuration, the housing may be formed at least in sections by casting the stator lines, rotor lines, and/or the ferrite core.

According to some embodiments, the housing may be L-shaped or I-shaped, wherein the first connection region and the second connection region are spaced apart from one another by the ferrite core. Such a configuration may enable the housing to specify the arrangement of the connection regions and make the connection regions mechanically rigid. Such a configuration may enable the connection arrangement to be particularly robust.

### BRIEF DESCRIPTION OF THE SEVERAL VIEWS OF THE DRAWINGS

FIG. 1 shows a perspective view of a connection arrangement.

FIG. 2 shows a cross-sectional perspective view of an electric motor arrangement.

### DETAILED DESCRIPTION

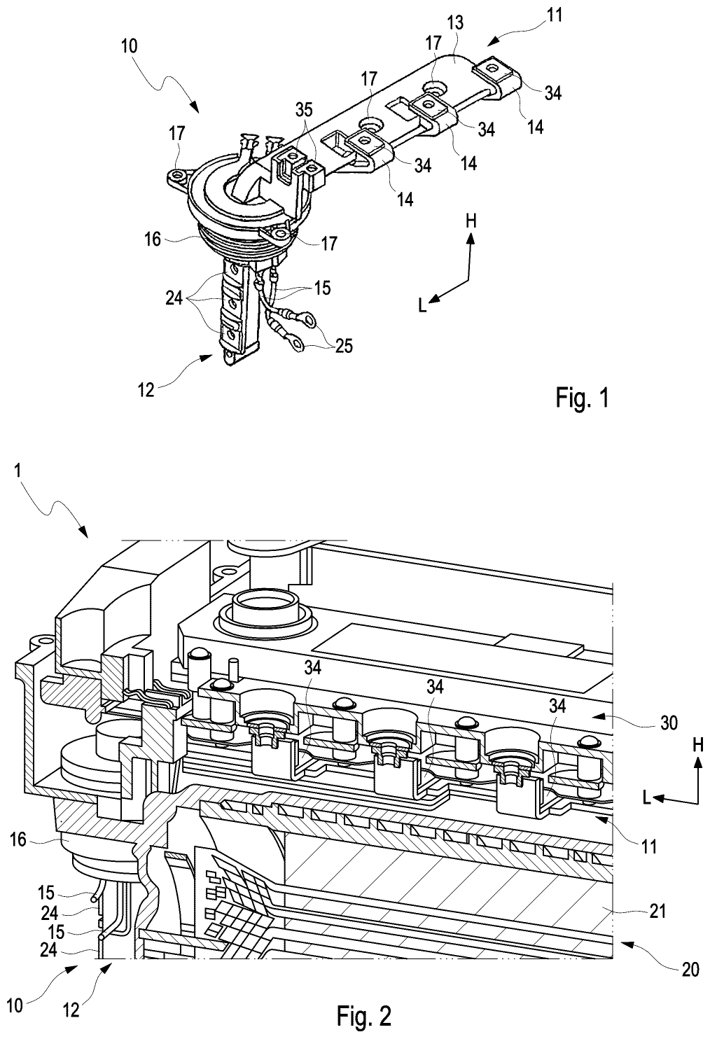

FIG. 1 shows a connection arrangement 10 according to an exemplary embodiment according to the present disclosure. Connection arrangement 10 may be configured to form an electrically conductive connection between an electric motor 20 and power electronics system 30 for controlling the electric motor 20 (see FIG. 2).

In addition to an electrical connection, the connection arrangement 10 may also establish a mechanical coupling between power electronics system 30 and electric motor 20. In this case, connection arrangement 10 may act as a contact bridge between electric motor 20 and power electronics system 30.

Connection arrangement 10 may have a first connection region 11 and a second connection region 12. First connection region 11 may be configured to electrically couple to power electronics system 30. Second connection region 12 may be configured to electrically couple to electric motor 20. For this purpose, a housing 13 may be provided, which may act as a mechanically rigid framework and may form connection regions 11, 12 in the form of two spaced-apart plateaus. Housing 13 is L-shaped in the exemplary embodiment shown.

Furthermore, connection arrangement 10 may have, for example, three stator lines 14 and two rotor lines 15. Stator lines 14 and rotor lines 15 may run between first connection region 11 and second connection region 12 and may have first connection contacts 34, 35 in first connection region 11 and second connection contacts 24, 25 in second connection region 12.

First connection region 11 may be spaced apart from second connection region 12 by a ferrite core 16. Stator lines 14 may be guided through ring-shaped ferrite core 16. Ferrite core 16 may also form a pivot point at which connection regions 11, 12 may have a different orientation or alignment. In this case, first connection region 11 may be aligned in height direction H. Second connection region 12 may be rotated by 90° and aligned in length direction L.

Connection arrangement 10 furthermore may have a plurality of fastening openings 17 which are configured to screw connection arrangement 10 to other components or structural components.

FIG. 2 shows an electric motor arrangement 1 according to an exemplary embodiment according to the present disclosure. Electric motor arrangement 1 may have, for example, an electric motor 20 and power electronics system 30. Power electronics system 30 may be configured, for example, in the form of a pulse inverter. Electric motor 20 is configured as an externally excited synchronous machine in the exemplary embodiment shown.

Furthermore, FIG. 2 schematically illustrates a part of a stator 21 of electric motor 20 in the form of a sectional view. Stator 21 may be supplied with electrical energy via stator lines 14. A rotor (not shown) may be supplied with electrical energy via rotor lines 15. The corresponding electrical energy supply is provided by power electronics system 30, which may be placed on connection arrangement 10, such as on first connection region 11, and may be in the form of a module. Due to the L-shape of housing 13, second connection region 12 may run laterally next to electric motor 20 and may be electrically contacted there. Connection arrangement 10 may thus form an electrical and mechanical bridge between electric motor 20 and power electronics system 30.

German patent application no. 102023132589.2 filed Nov. 22, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A connection arrangement for electrically connecting a power electronics system to a stator and an externally excited rotor of an electric motor, the connection arrangement comprising:
a first connection region configured to electrically couple to the power electronics system, the first connection region being rigidly configured;
a second connection region configured to electrically couple to the stator and the externally excited rotor of the electric motor;
at least two stator lines;
at least two rotor lines;
first connection contacts in the first connection region; and
second connection contacts in the second connection region,
wherein the at least two stator lines and the at least two rotor lines extend between the first connection region and the second connection region, and
wherein the first connection region is connected to the second connection region.

2. The connection arrangement according to claim 1, wherein the first connection region is oriented 90° relative to the second connection region.

3. The connection arrangement according to claim 1, wherein the first connection contacts are configured to be electrically contacted along a height direction and the second connection contacts are configured to be electrically contacted along a length direction.

4. The connection arrangement according to claim 1, further comprising at least one ferrite core.

5. The connection arrangement according to claim 4, wherein the ferrite core is configured to be annular, wherein at least the at least two stator lines are guided through the ferrite core.

6. The connection arrangement according to claim 4, further comprising a housing configured to receive and fasten the at least two stator lines, the at least two rotor lines, and/or the ferrite core.

7. The connection arrangement according to claim 1, wherein the first connection contacts and/or the second connection contacts are configured as cable end sections, contact plates, screw connections, and/or plug connections.

8. The connection arrangement according to claim 1, further comprising a housing configured to receive and fasten the at least two stator lines and/or the at least two rotor lines.

9. The connection arrangement according to claim 8, wherein the housing is L-shaped or I-shaped, and
wherein the first connection region and the second connection region are spaced apart from one another by the ferrite core.

10. An electric motor arrangement comprising:
at least one electric motor;
at least one power electronics system; and
at least one connection arrangement, each connection arrangement including:
a first connection region configured to electrically couple to a power electronics system, the first connection region being rigidly configured;
a second connection region configured to electrically couple to the stator and an externally excited rotor of an electric motor;
at least two stator lines;
at least two rotor lines;
first connection contacts in the first connection region; and
second connection contacts in the second connection region,
wherein the at least two stator lines and the at least two rotor lines extend between the first connection region and the second connection region, and
wherein the first connection region is connected to the second connection region, and
wherein the at least one power electronics system is electrically connected to the first connection region of the at least one connection arrangement and the at least one electric motor is electrically connected to the second connection region of the at least one connection arrangement.

11. A vehicle comprising:
at least one electric motor arrangement comprising
at least one electric motor;
at least one power electronics system; and
at least one connection arrangement, each connection arrangement including:
a first connection region configured to electrically couple to a power electronics system, the first connection region being rigidly configured;
a second connection region configured to electrically couple to the stator and an externally excited rotor of an electric motor;
at least two stator lines;
at least two rotor lines;
first connection contacts in the first connection region; and
second connection contacts in the second connection region,
wherein the at least two stator lines and the at least two rotor lines extend between the first connection region and the second connection region, and
wherein the first connection region is connected to the second connection region, and
wherein the at least one power electronics system is electrically connected to the first connection region of the at least one connection arrangement and the at least one electric motor is electrically connected to the second connection region of the at least one connection arrangement.
